(19) United States
(12) Patent Application Publication
(10) Pub. No.: US 2018/0043510 A1
(43) Pub. Date: Feb. 15, 2018

(54) HIGH-PRECISION TWO-PART FLAT CHUCK DEVICE AND PROCESSING APPARATUS INSTALLED THERE-WITH

(71) Applicant: JIA XING CLG PRECISION AUTOMATION MACHINE WIRING CO., LTD, JIAXING (CN)

(72) Inventor: CHANGXIAN QIU, JIAXING (CN)

(73) Assignee: JIA XING CLG PRECISION AUTOMATION MACHINE WIRING CO., LTD

(21) Appl. No.: 15/728,698

(22) Filed: Oct. 10, 2017

Related U.S. Application Data
(63) Continuation of application No. PCT/CN2016/078832, filed on Apr. 8, 2016.

(30) Foreign Application Priority Data
Apr. 10, 2015 (CN) 201510166628.3
Jun. 18, 2015 (CN) 201510339519.7

(51) Int. Cl. B25B 11/00; B23Q 15/00; B23Q 7/00; B23C 9/00; B23Q 1/00; B23Q 5/40

(52) U.S. Cl. CPC B25B 11/00; B23Q 1/0045; B23Q 5/40; B23Q 7/00; B23C 9/00; B23Q 15/00; B23Q 11/005

(57) ABSTRACT

A high-precision two-part flat chuck device includes: a base, a cylinder, a sliding plate, a first clamping plate and a second clamping pate. A piston rod of the cylinder is connected with the sliding plate. Precision sliding rails are arranged at two sides of the base, and two sides of the sliding plate are respectively matched with the precision sliding rails in a sliding manner. An accommodating groove is arranged in a middle part of the sliding plate. The first and second clamping plates are symmetrically distributed in the accommodating groove along a center of the sliding plate, and a spring is arranged between the first and second clamping plates. Side surfaces of the first and second clamping plates are inclined planes, and chucks matched with each other are arranged at end parts of the first and seconding clamp plates.

### CROSS-REFERENCE TO RELATED APPLICATIONS

This application is a continuation of International Patent Application No. PCT/CN2016/078832 with a filing date of Apr. 8, 2016, designating the United States, now pending, and further claims priority to Chinese Patent Applications No. 201510166628.3 with a filing date of Apr. 10, 2015 and No. 201510339519/ with a filing date Jun. 18, 2015. The content of the aforementioned applications, including any intervening amendments thereto, are incorporated herein by reference.

### FIELD OF THE INVENTION

The present invention relates to a part processing equipment, and particularly refers to a high-precision two-part flat chuck device and a processing equipment equipped with the device.

### BACKGROUND OF THE INVENTION

Currently, some precision components on the market, such as automobile components, optical instruments and the like, require relatively high precision; therefore, during secondary processing, a workpiece needs to be located through a fixture and then processed. However, at present, a current clamping or locating way is to clamp and locate with an elastic chuck or a vice clamp. Since a vice is in an alternate static and dynamic way, and a symmetry center thereof is uncertain, an error is easily caused when the workpiece is repeatedly clamped. Moreover, due to a limited processing space, the workpiece could be only punched horizontally, and cannot be longitudinally flattened, and thus, a processing range is limited. When the precision component is subjected to the secondary processing, degree of symmetry is poor and the repeated clamping easily causes the deviation of a central position. Thus, the processing precision of the workpiece is directly affected, causing poor stability and low precision.

In addition, the degree of symmetry of a traditional processed and drilled high-precision micro precision component with an axis center fully relies on manual operation, which is time-consuming and low in precision; and the degree of symmetry and precision of a flat milling groove of the traditional high-precision micro precision component with the axis center also fully rely on the manual operation, causing time-consuming in adjustment, complicated machines, low precision and no automation.

### SUMMARY OF THE INVENTION

To overcome disadvantages and defects of the background art, the present invention provides a high-precision two-part flat chuck device and a processing equipment equipped with the device, so as to solve technical problems of horizontal punching and symmetry precision of the high-precision micro precision component as well as head milling, symmetry of a flat position, a groove depth and the like due to manual adjustment.

A high-precision two-part flat chuck device comprises a base, a cylinder, a sliding plate, a first clamping plate and a second clamping pate. A piston rod of the cylinder is connected with the sliding plate. Precision sliding rails are arranged at two sides of the base and two sides of the sliding plate are respectively matched with the precision sliding rails in a sliding manner. An accommodating groove is arranged in a middle part of the sliding plate. The first clamping plate and the second clamping plate are symmetrically distributed in the accommodating groove along a center of the sliding plate, and a spring is arranged between the first clamping plate and the second clamping plate. Side surfaces of the first clamping plate and the second clamping plate are inclined planes. Rollers are arranged at two sides of the sliding plate. The rollers at the two sides are respectively matched with the inclined planes of the first clamping plate and the second clamping plate in an extrusion manner, and chucks matched with each other are arranged at end parts of the first clamping plate and the second clamping plate.

The high-precision two-part flat chuck device further comprises a cleaning mechanism. The cleaning mechanism comprises a locating plate and a high-pressure air pipe. The cylinder is located between the locating plate and the sliding plate. A gap is formed between the first clamping plate and the second clamping plate. The high-pressure air pipe is fixed on the locating plate and corresponds to the gap by penetrating through the piston rod of the cylinder.

A through hole communicated with the first clamping plate and the second clamping plate is formed above the sliding plate.

The present invention further provides a processing equipment of a high-precision micro precision component, comprising a support, a vibrating disk, a feed manipulator, a high-precision two-part flat chuck device and an unloading manipulator. A punching device is also arranged on the support and comprises a servo motor, a screw, a sliding sleeve, an installation seat, a guide rail, an electronic shaft and a drill. The servo motor drives the screw to rotate. The sliding sleeve is matched with the screw by threads. The installation seat is matched with the guide rail in a sliding manner and fixedly connected with the sliding sleeve. The electronic shaft is fixed on the installation seat. The drill is installed on the electronic shaft and matched with the high-precision two-part flat chuck device.

A milling groove device is also arranged on the support and comprises a first servo motor, a first screw, a first sliding sleeve, a first installation seat, a first guide rail, a variable frequency motor and a milling cutter. The first servo motor drives the first screw to rotate. The first sliding sleeve is matched with the first screw by threads. The first installation seat is matched with the first guide rail in a sliding manner and fixedly connected with the first sliding sleeve. The variable frequency motor is fixed on the first installation seat. The milling cutter is installed on an output shaft of the variable frequency motor and matched with the high-precision two-part flat chuck device.

The support comprises a first support and a second support distributed in the left and right. The high-precision two-part flat chuck device is located between the first support and the second support. The punching device is correspondingly distributed above the first support and the second support respectively. The milling groove device is located below the first support, and the high-precision two-part flat chuck device is transported to the milling groove device through the transportation mechanism from top to bottom.

The transportation mechanism comprises a second servo motor a second screw, a second sliding sleeve, a second installation seat and a second guide rail. The second servo motor drives the second screw to rotate. The second sliding sleeve is fixedly connected with the second installation seat and matched with the second screw by threads. The second installation seat is matched with the second guide rail in a sliding manner. The high-precision two-part flat chuck device is fixedly connected with the second installation seat.

The processing equipment further comprises an adjusting device for adjusting the high-precision two-part flat chuck device to move forwards and backwards. The adjusting device comprises a third servo motor, a third screw, a third sliding sleeve, a third installation seat and a third guide rail. The third servo motor drives the third screw to rotate. The third sliding sleeve is matched with the third screw by threads. The third installation seat is matched with the third guide rail in a sliding manner. The high-precision two-part flat

The processing equipment further comprises a machine base, and a control box is arranged on the machine base and used to control actions of the punching device, the milling groove device, the adjusting device and the transportation mechanism.

The high-precision two-part flat chuck device has the following beneficial effects: since the sliding plate is connected with the precision sliding rails, a position of a center line of the sliding plate is not changed in each slippage. When the sliding plate is operated, an inclined plate that the inclined planes are located is driven to operate (note: the inclined plate is connected with the flat chucks). A position of a symmetrical center line of the sliding plate is always kept unchanged, and a repeated damping position of workpiece is not changed, thereby realizing high center, good symmetry, high stability and high precision.

The processing equipment has the following beneficial effects: (1) horizontal punching and symmetry precision of the high-precision micro precision component are thoroughly solved, and timely digital operation can be realized independent of technicians; (2) problems of head milling, symmetry of a flat position, a groove depth and the like of the high-precision micro precision component due to manual adjustment are thoroughly solved; problems of instability of many front and rear mechanical mechanisms for manually adjusting the milling cutter, low precision, technical requirements of personnel and the like are changed; full-digital adjustment is realized by intelligently designing a mechanical mechanism to enable a cutter body not to move and a part to move, which is convenient, accurate and intelligent; and (3) the equipment has an independently developed system, thereby realizing simple and efficient full-digital adjustment mode.

### BRIEF DESCRIPTION OF THE DRAWINGS

FIG. 1 is top view of an embodiment of a high-precision two-part flat chuck device in the present invention;

FIG. 2 is three-dimensional view of an embodiment of a high-precision two-part flat chuck device in the present invention;

FIG. 3 is a structural schematic diagram of an embodiment of a processing equipment in the present invention;

FIG. 4 is a structural enlarged diagram of A place in FIG. 3;

FIG. 5 is an internal structural diagram of FIG. 4;

FIG. 6 is a structural diagram of an embodiment of a processing equipment in the present invention from another angle; and

FIG. 7 is a structural diagram of an embodiment of a processing equipment in the present invention from another angle.

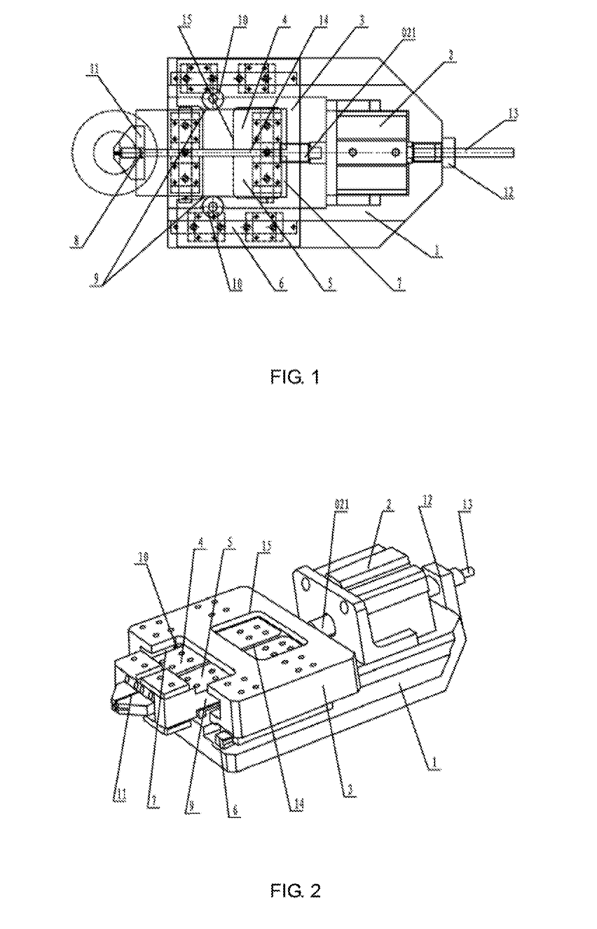

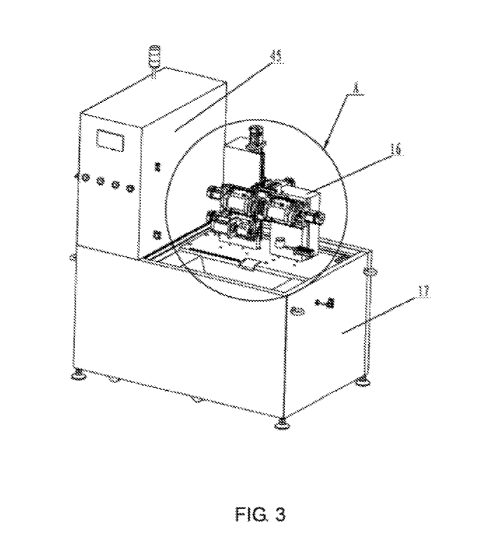

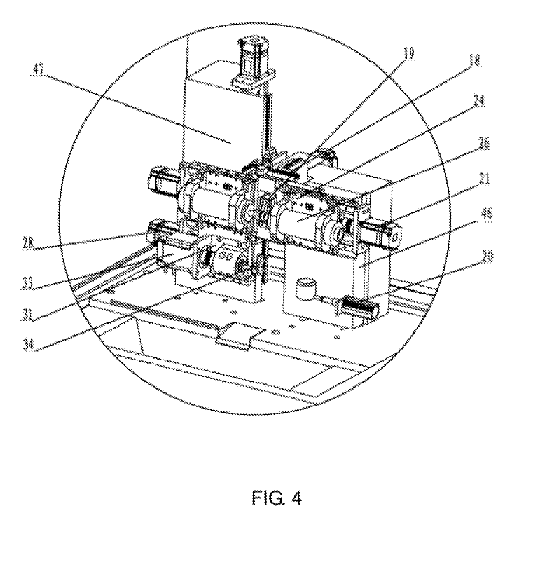

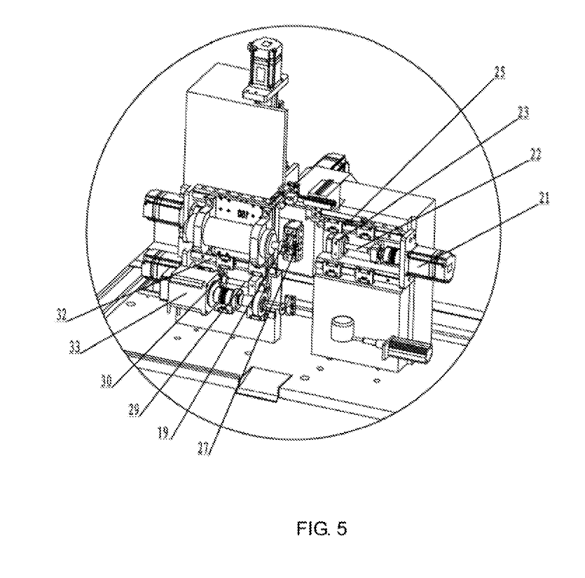

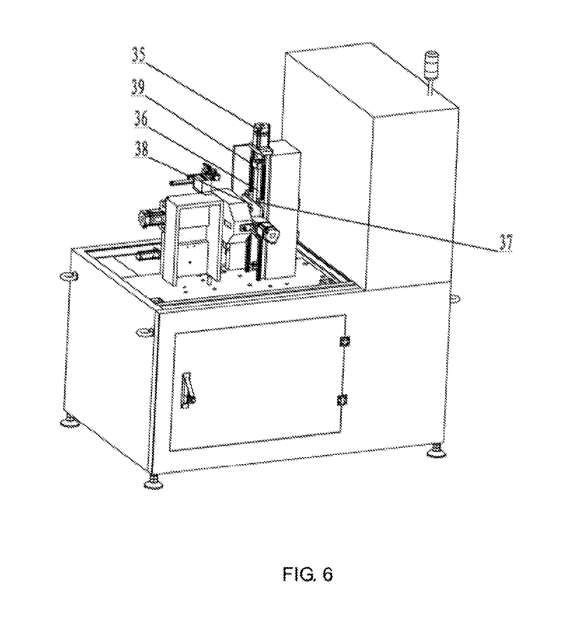

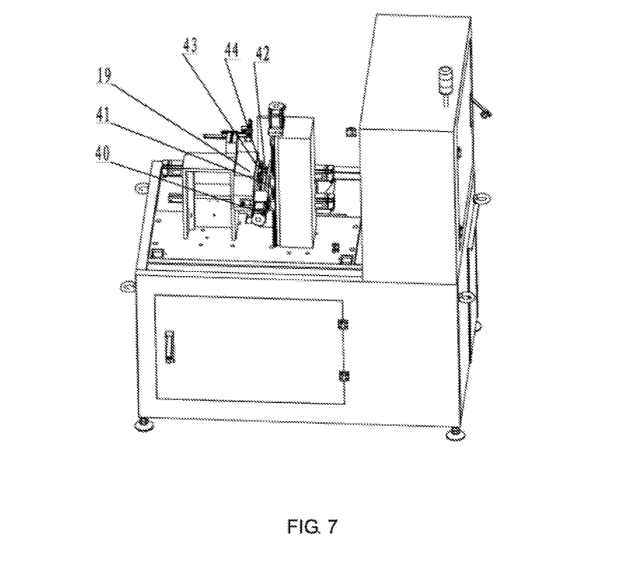

In the figures: base 1; cylinder 2; piston rod 021; sliding plate 3; first clamping plate 4; second clamping plate 5; precision sliding rail 6; accommodating groove 7; spring 8; inclined plane 9; roller 10; chuck 11; locating plate 12; high-pressure air pipe 13; gap 14; through hole 15; support 16; machine base 17; feed manipulator 18; high-precision two-part flat chuck device 19; unloading manipulator 20; servo motor 21; screw 22; sliding sleeve 23; installation seat 24; guide rail 25; electronic shaft 26; drill 27; first servo motor 28; first screw 29; first sliding sleeve 30; first installation seat 31; first guide rail 32; variable frequency motor 33; milling cutter 34; second servo motor 35; second screw 36; second sliding sleeve 37; second installation seat 38; second guide rail 39; third servo motor 40; third screw 41; third sliding sleeve 42; third installation seat 43; third guide rail 44; control box 45; first support 46; and second support 47.

### DETAILED DESCRIPTION OF THE EMBODIMENTS

Embodiments of the present invention are further described in detail n combination with drawings now. The drawings are simplified schematic diagrams, only illustrate a basic structure of the present invention in a schematic way, and thus, only show a composition related to the present invention.

As shown in the figure, a high-precision two-part flat chuck device 19 comprises a base 1, a cylinder 2, a sliding plate 3, a first clamping plate 4 and a second clamping pate 5. A piston rod 021 of the cylinder 2 is connected with the sliding plate 3. Precision sliding rails 6 are arranged at two sides of the base 1 and two sides of the sliding plate 3 are respectively matched with the precision sliding rails 6 in a sliding manner. An accommodating groove 7 is arranged in a middle part of the sliding plate 3. The first clamping plate 4 and the second damping plate 5 are symmetrically distributed in the accommodating groove 7 along a center of the sliding plate 3, and a spring 8 is arranged between the first clamping plate 4 and the second clamping plate 5. Side surfaces of the first clamping plate 4 and the second clamping plate 5 are inclined planes 9. Rollers 10 are arranged at two sides of the sliding plate 3. The rollers 10 at the two sides are respectively matched with the inclined planes 9 of the first clamping plate 4 and the second clamping plate 5 in an extrusion manner, and chucks 11 matched with each other are arranged at end parts of the first clamping plate 4 and the second clamping plate 5. The base 1 is platy. The precision sliding rails 6 are arranged at the two sides of the base 1 respectively and the two sides of the sliding plate 3 are respectively matched with the precision sliding rails 6. The first clamping plate 4 and the second clamping plate 5 are located in the accommodating groove 7. The chucks 11 are arranged at the end parts of the first clamping plate 4 and the second clamping plate 5, and the rollers 10 are arranged on the sliding plate 3 and located inside the accommodating groove 7, so that the rollers 10 just come into contact with the side surfaces of the first clamping plate 4 and the second clamping plate 5. The sliding plate 3 is in an integrated structure. When processing is not carried out, the chunks 11 on the first clamping plate 4 and the second clamping plate 5 are expanded due to an action of the spring 8, and the cylinder 2 does not act, i.e., the sliding plate 3 is in the rear of the chucks 11 at this time. When processing is required, a component is placed between the chucks 11, and the cylinder 2 acts to stretch outward to push the sliding plate 3 to slide forward along the precision sliding rails 6 and drive the rollers 10 to slide along the inclined planes 9, so as to simultaneously extrude the first clamping plate 4 and the second clamping plate 5 to approach with each other, to drive clamping components of the chucks 11 on the clamping plates for secondary processing. After processing is completed, the piston rod 021 of the cylinder 2 drives the sliding plate 3 to move backward to loosen the component and then discharge. Therefore, the synchronicity is good. According to the above solution, since the sliding plate 3 is connected with the precision sliding rails 6, a position of a center line of the sliding plate 3 is not changed in each slippage. When the sliding plate 3 is operated, an inclined plate that the inclined planes 9 are located is driven to operate (note: the inclined plate is connected with the flat chucks 11). A position of a symmetrical center line of the sliding plate 3 is always kept unchanged, and a repeated clamping position of workpiece is not changed, thereby realizing high center, good symmetry, high stability and high precision.

In the present invention, the high-precision two-part flat chuck device further comprises a cleaning mechanism. The cleaning mechanism comprises a locating plate 12 and a high-pressure air pipe 13. The cylinder 2 is located between the locating plate 12 and the sliding plate 3. A gap 14 is formed between the first clamping plate 4 and the second clamping plate 5. The high-pressure air pipe 13 is fixed on the locating plate 12 and corresponds to the gap 14 by penetrating through the piston rod 021 of the cylinder 2. The gap 14 is formed between the first clamping plate 4 and the second clamping plate 5 and correspondingly arranged between the two chucks 11. After the workpiece is processed, the generated waste and impurities need to be eliminated. Therefore, cleaning is carried out through gas blown from the high-pressure air pipe 13. With the above eliminating way, the high-precision two-part flat chuck device has reasonable and compact structural distribution, high cleaning effect, and high efficiency.

In embodiments of the present invention, a through hole 15 communicated with the first clamping plate 4 and the second clamping plate 5 is formed above the sliding plate 3, and the first clamping plate 4 and the second clamping plate 5 could be observed through the through hole 15, so as to facilitate maintenance.

As shown in the figure, a processing equipment of a high-precision micro precision component comprises a support 16, a vibrating disk, a feed manipulator 18, a high-precision two-part flat chuck device 19 and an unloading manipulator 20. A punching device is also arranged on the support 16 and comprises a servo motor 21, a screw 22, a sliding sleeve 23, an installation seat 24, a guide rail 25, an electronic shaft 26 and a drill 27, The servo motor 21 drives the screw 22 to rotate. The sliding sleeve 23 is matched with the screw 22 by threads. The installation seat 24 is matched with the guide rail 25 in a sliding manner and fixedly connected with the sliding sleeve 23. The electronic shaft 26 is fixed on the installation seat 24. The drill 27 is installed on the electronic shaft 26 and matched with the high-precision two-part flat chuck device 19. The servo motor 21 is started to drive the screw 22 to rotate. The screw 22 is matched with the sliding sleeve 23 in a spiral manner ad drives the sliding sleeve 23 to axially move when rotating, thereby driving the installation seat 24 to slide along the guide rail 25. The installation seat 24 drives the drill 27 of the electronic shaft 26 to axially move to close to chucks 11 of the high-precision two-part flat chuck device 19, thereby punching a precision component in the chucks 11. According to the above solution, the precision component is punched through the punching device, thereby thoroughly solving horizontal punching and symmetry precision of the high-precision micro precision component, realizing timely digital operation independent of technicians, and realizing a simple and efficient full-digital adjustment mode.

In embodiments of the present invention, a milling groove device is also arranged on the support 16 and comprises a first servo motor 28, a first screw 29, a first sliding sleeve 30, a first installation seat 31, a first guide rail 32, a variable frequency motor 33 and a milling cutter 34. The first servo motor 28 drives the first screw 29 to rotate. The first sliding sleeve 30 is matched with the first screw 29 by threads. The first installation seat 31 is matched with the first guide rail 32 in a sliding manner and fixedly connected with the first sliding sleeve 30. The variable frequency motor 33 is fixed on the first installation seat 31. The milling cutter 34 is installed on an output shaft of the variable frequency motor 33 and matched with the high-precision two-part flat chuck device 19. The first servo motor 28 is started to drive the first screw 29 to rotate. The first screw 29 is matched with the first sliding sleeve 30 in a spiral manner. The first screw 29 drives the first sliding sleeve 30 to axially move when rotating, thereby driving the first installation seat 31 to slide along the first guide rail 32. The first installation seat 31 drives the variable frequency motor 33 to move, and the variable frequency motor 33 drives the milling cutter 34 to rotate to punch a precision component in chucks 11, thereby thoroughly solving problems of head milling, symmetry of a flat position, a groove depth and the like of the high-precision micro precision component due to manual adjustment and changing problems of instability of many front and rear mechanical mechanisms for manually adjusting the milling cutter 34, low precision, technical requirements of personnel and the like. Moreover, full-digital adjustment is realized by intelligently designing a mechanical mechanism to enable a cutter body not to move and a part to move, which is convenient, accurate and intelligent. The processing equipment further comprises a machine base 17, and a control box 45 is arranged on the machine base 17 and used to control actions of the punching device, the milling groove device, an adjusting device and a transportation mechanism.

In embodiments of the present invention, the support 16 comprises a first support 46 and a second support 47 distributed in the left and right. The high-precision two-part flat chuck device 19 is located between the first support 46 and the second support 47. The punching device is correspondingly distributed above the first support 46 and the second support 47 respectively. The milling groove device is located below the first support 46, and the high-precision two-part flat chuck device 19 is transported to the milling groove device through the transportation mechanism from top to bottom. With the above distribution structure, the transportation mechanism drives the high-precision two-part flat chuck device 19 to move downwards after the micro precision component is subjected to automatic punching in a double-drill region, to transport to a milling groove region, thereby milling the precision component through the milling groove device.

In embodiments of the present invention, the transportation mechanism comprises a second servo motor 35 a second screw 36, a second sliding sleeve 37, a second installation seat 38 and a second guide rail 39. The second servo motor 35 drives the second screw 36 to rotate. The second sliding sleeve 37 is fixedly connected with the second installation seat 38 and matched with the second screw 36 by threads. The second installation seat 38 is matched with the second guide rail 39 in a sliding manner. The high-precision two-part flat chuck device 19 is fixedly connected with the second installation seat 38. The above transportation mechanism is adopted, thereby realizing stable transmission, high precision and convenient control, to achieve advantages of digital adjustment, convenience, accuracy, intelligence and the like.

In embodiments of the present invention, the processing equipment further comprises an adjusting device for adjusting the high-precision two-part flat chuck device 19 to move forwards and backwards. The adjusting device comprises a third servo motor 40, a third screw 41, a third sliding sleeve 42, a third installation seat 43 and a third guide rail 44. The third servo motor 40 drives the third screw 41 to rotate. The third sliding sleeve 42 is matched with the third screw 41 by threads. The third installation seat 43 is matched with the third guide rail 44 in a sliding manner. The high-precision two-part flat chuck device 19 is fixedly connected with the third installation seat 43. According to needs, the adjustment of front and rear positions of the product hole is realized, and the adjustment of end milling, symmetry of the flat position, the groove depth and the like is realized, thereby meeting a processing requirement.

An operating principle in embodiments of the present invention is as follows: the product is poured into the vibrating disk manually, and the product diameter is φ1-φ2. The vibrating disk automatically recognizes front and rear directions of the product; the product enters the feed manipulator through a passageway after confirming the directions; the manipulator sends the product into the high-precision chucks 11 automatically; a main shaft starts to decline after the machine perceives that the product is in place; the product is punched in the double-drill region automatically and then declined into the milling region after punched; the milling groove starts to mill after perceiving that the product is in place; and a receiving manipulator receives materials and separates scrap materials after completing milling.

Above embodiments of the present invention shall not be regarded as a limitation to the present invention. However, any improvement made based on sprits of the present invention shall be included in a protection scope of the present invention.

What is claimed is:

1. A high-precision two-part flat chuck device, comprising a base (1) a cylinder (2), a sliding plate (3), a first clamping plate (4) and a second clamping pate (5), wherein a piston rod (021) of the cylinder (2) is connected with the sliding plate (3); precision sliding rails (6) are arranged at two sides of the base (1) and two sides of the sliding plate (3) are respectively matched with the precision sliding rails (6) in a sliding manner, an accommodating groove (7) is arranged in a middle part of the sliding plate (3); the first clamping plate (4) and the second clamping plate (5) are symmetrically distributed in the accommodating groove (7) along a center of the sliding plate (3); a spring (8) is arranged between the first clamping plate (4) and the second clamping plate (5); side surfaces of the first clamping plate (4) and the second clamping plate (5) are inclined planes (9); rollers (10) are arranged at two sides of the sliding plate (3); the rollers (10) at the two sides are respectively matched with the inclined planes (9) of the first clamping plate (4) and the second clamping plate (5) in an extrusion manner; and chucks (11) matched with each other are arranged at end parts of the first clamping plate (4) and the second clamping plate (5).

2. The high-precision two-part flat chuck device according to claim 1, wherein the high-precision two-part flat chuck device further comprises a cleaning mechanism; the cleaning mechanism comprises a locating plate (12) and a high-pressure air pipe (13); the cylinder (2) is located between the locating plate (12) and the sliding plate (13); a gap is formed between the first clamping plate (4) and the second clamping plate (5); and the high-pressure air pipe (13) is fixed on the locating plate (12) and corresponds to the gap (14) by penetrating through the piston rod (021) of the cylinder (2).

3. The high-precision two-part flat chuck device according to claim 1, wherein a through hole (15) communicated with the first clamping plate (4) and the second clamping plate (5) is formed above the sliding plate (3).

4. A processing equipment of a high-precision micro precision component, comprising a support (16), a vibrating disk, a feed manipulator (18), a high-precision two-part flat chuck device (19) according to claim 1, and an unloading manipulator (20), wherein a punching device is also arranged on the support (16) and comprises a servo motor (21), a screw (22), a sliding sleeve (23), an installation seat (24), a guide rail (25), an electronic shaft (26) and a drill (27); the servo motor (21) drives the screw (22) to rotate; the sliding sleeve (23) is matched with the screw (22) by threads; the installation seat (24) is matched with the guide rail (25) in a sliding manner and fixedly connected with the sliding sleeve (23); the electronic shaft (26) is fixed on the installation seat (24); and the drill (27) is installed on the electronic shaft (26) and matched with the high-precision two-part flat chuck device (19).

5. The processing equipment of the high-precision micro precision component according to claim 4, wherein a milling groove device is also arranged on the support (16) and comprises a first servo motor (28), a first screw (29), a first sliding sleeve (30), a first installation seat (31), a first guide rail (32), a variable frequency motor (33) and a milling cutter (34); the first servo motor (28) drives the first screw (29) to rotate; the first sliding sleeve (30) is matched with the first screw (29) by threads; the first installation seat (31) is matched with the first guide rail (32) in a sliding manner and fixedly connected with the first sliding sleeve (30); the variable frequency motor (33) is fixed on the first installation seat (31); the milling cutter (34) is installed on an output shaft of the variable frequency motor (33) and matched with the high-precision two-part flat chuck device (19).

6. The processing equipment of the high-precision micro precision component according to claim 5, wherein the support (16) comprises a first support (46) and a second support (47) distributed in the left and right; the high-precision two-part flat chuck device (19) is located between the first support (46) and the second support (47); the punching device is correspondingly distributed above the first support (46) and the second support (47) respectively; the milling groove device is located below the first support (46), and the high-precision two-part flat chuck device (19) is transported to the milling groove device through the transportation mechanism from top to bottom.

7. The processing equipment of the high-precision micro precision component according to claim 6, wherein the transportation mechanism comprises a second servo motor (35), a second screw (36), a second sliding sleeve (37), a second installation seat (38) and a second guide rail (39); the second servo motor (35) drives the second screw (36) to rotate; the second sliding sleeve (37) is fixedly connected with the second installation seat (38) and matched with the second screw (36) by threads; the second installation seat (38) is matched with the second guide rail (39) in a sliding manner; and the high-precision two-part flat chuck device (19) is fixedly connected with the second installation seat (38).

8. The processing equipment of the high-precision micro precision component according to claim 7, wherein the processing equipment further comprises an adjusting device for adjusting the high-precision two-part flat chuck device (19) to move forwards and backwards; the adjusting device comprises a third servo motor (40), a third screw (41), a third sliding sleeve (42), a third installation seat (43) and a third guide rail (44); the third servo motor (40) drives the third screw (41) to rotate; the third sliding sleeve (42) is matched with the third screw (41) by threads; the third installation seat (43) is matched with the third guide rail (44) in a sliding manner; and the high-precision two-part flat chuck device (19) is fixedly connected with the third installation seat (43).

9. The processing equipment of the high-precision micro precision component according to claim 8, wherein the processing equipment further comprises a machine base (17), and a control box (45) is arranged on the machine base (17) and used to control actions of the punching device, the milling groove device, the adjusting device and the transportation mechanism.
